(19) United States
(12) Patent Application Publication
(10) Pub. No.: US 2025/0292369 A1
(43) Pub. Date: Sep. 18, 2025

(54) IMAGE PROCESSING APPARATUS, IMAGING APPARATUS, AND CONTROL METHOD OF IMAGE PROCESSING APPARATUS

(71) Applicant: CANON KABUSHIKI KAISHA, Tokyo (JP)

(72) Inventor: YOICHI TAKAHASHI, Tokyo (JP)

(21) Appl. No.: 19/078,130

(22) Filed: Mar. 12, 2025

(30) Foreign Application Priority Data
Mar. 14, 2024 (JP) 2024-040477

(51) Int. Cl. G06T 5/50; G06T 7/11; H04N 23/667

(52) U.S. Cl. CPC G06T 5/50; G06T 7/11; G06T 2207/20021; G06T 2207/20092; G06T 2207/20212; H04N 23/667

(57) ABSTRACT

An image processing apparatus includes at least one memory storing instructions, and at least one processor in communication with the at least one memory and configured to execute the instructions. Execution of the instructions causes the at least one memory and the at least one processor to divide each of a plurality of images captured continuously over time into similar areas, generate a composite image from the plurality of images by synthesis processing, and control a display device to display the composite image, wherein the synthesis processing for each of the areas divided by the dividing is ended based on an end instruction.

### BACKGROUND

### Technical Field

An aspect of the embodiments relates to an image processing apparatus, an imaging apparatus, and a control method of an image processing apparatus, and in particular to an image synthesis technology.

### Description of the Related Art

An imaging method called bulb photography is known as long-exposure imaging. In bulb photography, a user issues instructions for exposure from a start to the end to capture an image. During the exposure, reading of image signals from the sensor is not performed, and thus the user cannot check brightness of the image being captured. That is, during the process, it is difficult for the user to check whether the image is captured with the desired brightness.

Japanese Patent Application Laid-Open No. 2005-117395 discusses that image signals are read periodically during exposure, sequential addition synthesis is performed, and the composite image is displayed on a display device. With this configuration, the user can check the change in brightness after a start of imaging and issue an instruction to end the exposure, that is, the end of the synthesis.

### SUMMARY

An image processing apparatus includes at least one memory storing instructions, and at least one processor in communication with the at least one memory and configured to execute the instructions. Execution of the instructions causes the at least one memory and the at least one processor to divide each of a plurality of images captured continuously over time into similar areas, generate a composite image from the plurality of images by synthesis processing, and control a display device to display the composite image, wherein the s synthesis processing for each of the areas divided by the dividing is ended based on an end instruction.

Further features of the disclosure will become apparent from the following description of exemplary embodiments with reference to the attached drawings.

### BRIEF DESCRIPTION OF THE DRAWINGS

FIG. 1 is a block diagram illustrating a functional configuration example of an imaging apparatus according to an exemplary embodiment.

FIG. 2 is a flowchart of operations in a composite imaging mode according to the exemplary embodiment.

FIGS. 3A and 3B are explanatory diagrams of a divided area setting method in the exemplary embodiment.

FIG. 4 is an explanatory diagram of composite images and display during imaging in the exemplary embodiment.

### DESCRIPTION OF THE EMBODIMENTS

Hereinafter, embodiments will be described in detail with reference to the attached drawings. Note, the following embodiments are not intended to limit the scope of every embodiment. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

Hereinafter, a description will be given of the exemplary embodiments in which an imaging apparatus, such as a digital camera, is used as an example of the present disclosure. The present disclosure can be implemented in a computer device (a personal computer, a tablet computer, a media player, a personal digital assistant (PDA) device, or the like), a smartphone, a game machine, a robot, a drone, or a drive recorder regardless of whether the computer device has an imaging function, as long as a plurality of images are combined. These are examples, and the present disclosure can be implemented in other electronic devices.

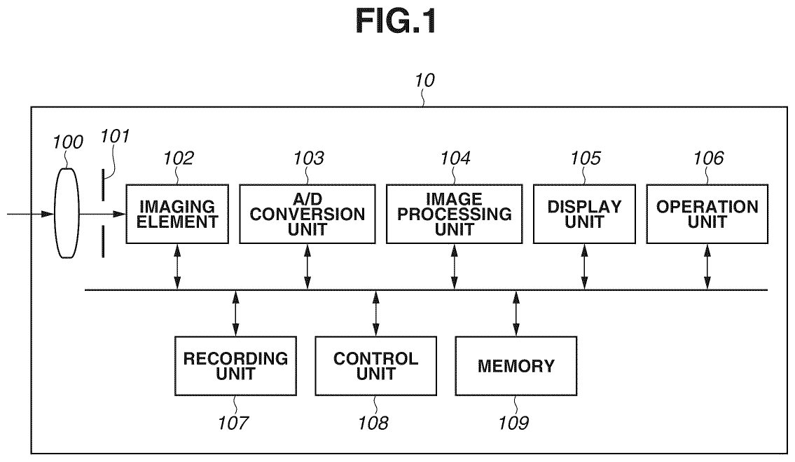

FIG. 1 is a block diagram illustrating a functional configuration example of an imaging apparatus 10 equipped with an image processing apparatus according to an exemplary embodiment of the disclosure.

A control unit 108 has one or more processors that execute programs, a random access memory (RAM), and a read only memory (ROM). The control unit 108 reads programs stored in the ROM into the RAM and executes the programs using the processor. The control unit 108 executes the programs to control operations of components of the imaging apparatus 10, including the functional blocks illustrated in FIG. 1 and/or operations of external devices communicably connected. The functions of the imaging apparatus 10 are implemented by the control unit 108 executing the programs. The functions that are able to be implemented by the control unit 108 executing the programs may be implemented using hardware (for example, an application specific integrated circuit (ASIC), a field programmable gateway (FPGA), or the like). The ROM is electrically rewritable, for example, and stores programs executable by the processor included in the control unit 108, setting values of the imaging apparatus 10, graphical user interface (GUI) data, and the like. The control unit 108 may be in the form of a system on chip (SoC) or a system on package (SiP), for example.

An imaging lens 100 has a plurality of lenses and an aperture, and generates an optical image of a subject. An imaging element 102 is a complementary metal oxide semiconductor (CMOS) image sensor, for example, and has a plurality of photoelectric conversion units (pixels) arranged two-dimensionally.

The pixels of the imaging element 102 generate pixel signals having values corresponding to the amount of charge generated during a charge accumulation period. In imaging with a mechanical shutter 101 being opened and closed, the charge accumulation period is equivalent to an exposure period. In imaging with the mechanical shutter 101 kept open, the charge accumulation period is equivalent to a period from when the accumulated charge is reset to when the exposure period has elapsed. In general, while the former corresponds to still image capturing and the latter to video capturing, the latter is also applicable to still image capturing. In a case where the imaging element 102 has a global shutter mechanism, the mechanical shutter 101 may not be used.

In response to the end of one charge accumulation period, a pixel signal group (analog image signals) for one frame is read out from the imaging element 102. In a case where the imaging element 102 outputs a pixel signal group in digital format, an analog/digital (A/D) conversion unit 103 may be omitted.

At this stage, each pixel signal has one color component alone corresponding to the color of the unit filter of the corresponding pixel. Such a digital image signal containing a pixel signal having one color component alone corresponding to the color of the unit filter will be herein called raw data.

The raw data output from the A/D conversion unit 103 or the imaging element 102 is temporarily stored in a memory 109. The memory 109 is used to temporarily store the raw data, image data processed by an image processing unit 104, and the like.

The image processing unit 104 applies development processing to the raw data. The development processing is a general term for a plurality of image processing operations, such as color interpolation and gradation correction (gamma processing). The color interpolation is processing for interpolating values of color components that are unobtainable at the time of imaging, and is also called a de-mosaic process. With application of the color interpolation, each pixel has a plurality of color components (for example, RGB or YCbCr) for a color image, and the data is no longer raw data.

Examples of processes that are applied by the image processing unit 104 include detection of feature regions (for example, face regions and human body regions) and their movements, and person recognition processing, synthesis processing, scaling processing, and encoding and decoding processing to the developed image data. Examples of various processes that are also applied by the image processing unit 104 include image processing including data processing, such as header information generation, generation of signals and evaluation values for use in autofocus detection (AF), and evaluation value calculation processing such as calculation of evaluation values for use in automatic exposure control (AE). These are examples of image processing that are applied by the image processing unit 104, and do not limit the image processing that the image processing unit 104 applies.

The image processing unit 104 also combines a plurality of captured raw data and stores the composite raw data in the memory 109.

As examples of modes of synthesis processing that are executable in the image processing unit 104, an addition synthesis mode, an addition averaging mode, and a comparative brightening mode are selectable, for example.

The image synthesis method in each of the synthesis processing modes will be described. In the present exemplary embodiment, N frames (N is an integer of 2 or more) of images will be combined. The pixels included in the image of each frame have coordinates (x, y) in an xy orthogonal coordinate system, the luminance value of the pixel at the coordinates (x, y) is I_i(x, y) (i=1 to N), and the luminance value of the pixel at the coordinates (x, y) of the composite image is I(x, y). The control unit 108 calculates the luminance value I(x, y) of each pixel of the composite image as described below, in accordance with the composite mode.

### Addition Synthesis Mode

$$I ( x , y ) = I\_ 1 ( x , y ) + I\_ 2 ( x , y ) + … + I\_N ( x , y )$$

In the addition synthesis mode, the control unit 108 generates a composite image by adding up the luminance values of pixels in frames at the same coordinates. The addition synthesis mode is used, for example, in generating an image with an appropriate exposure by combining N frames of images captured with an exposure amount of 1/N of the appropriate exposure amount.

### Addition Averaging Mode

$$I ( x , y ) = ( I\_ 1 ( x , y ) + I\_ 2 ( x , y ) + … + I\_N ( x , y ) ) / N$$

In the addition averaging mode, the control unit 108 generates a composite image in which the luminance values obtained in the same manner as in the addition synthesis mode are divided by the number of frames N, whereby the luminance value of each pixel is the average value of N frames. The addition averaging mode is used to reduce noise in an image captured at a high sensitivity, for example.

### Comparative Brightening Mode

$$I ( x , y ) = max I\_ 1 ( x , y ) , I\_ 2 ( x , y ) , … , I\_N ( x , y ) )$$

In the above equation, max( ) is a function that extracts the maximum value of the element in ( ). An obtained composite image has the maximum luminance value of N pixels that have the same coordinates in frames. The comparative brightening mode is effective in combining images of fireworks or a starry sky, for example.

A display unit 105 is a touch display, for example, and is used to display a live view image, a playback image, a GUI, setting values and information about the imaging apparatus 10, and the like.

An operation unit 106 is a general term for input devices (such as switches, keys, buttons, dials, and touch panel) that are used by a user to give various instructions to the imaging apparatus 10. For example, the display unit 105 is usable as a touch panel serving as a part of the operation unit 106.

A recording unit 107 records raw data, composite raw data, developed image data, and audio data associated with these data on a recording medium, such as a memory card, according to the imaging mode and recording settings.

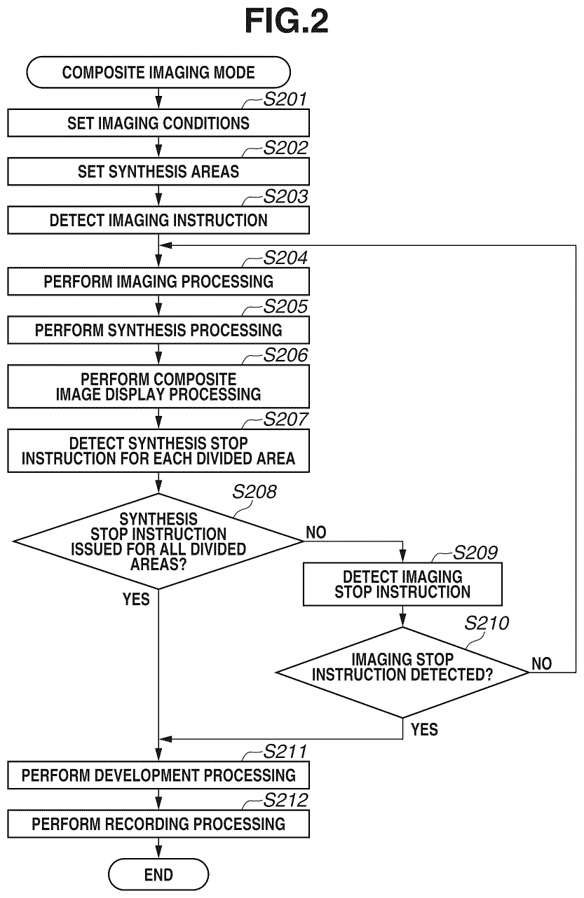

The operation of the imaging apparatus 10 in a mode of composite imaging will be described with reference to the flowchart of FIG. 2. The mode of the composite imaging is an imaging mode in which composite images obtained by combining a plurality of frames of images captured over time are displayed in sequence, the imaging (exposure) is ended in response to a user's instruction, and the images are recorded. While, in the present exemplary embodiment, the addition synthesis mode is used, the mode may also be configured to be selectable. In the composite imaging mode in the present exemplary embodiment, a plurality of frames of images captured over time are combined to apply an effect equivalent to a long exposure to the composite image.

In step S201, the control unit 108 accepts settings of imaging conditions from the user via the operation unit 106. The imaging conditions set in this processing are exposure conditions, such as sensitivity, aperture value, and shutter speed in sequential imaging. Based on the shutter speed in sequential imaging and the number of images to be combined, an effect equivalent to long exposure is applied to the composite image.

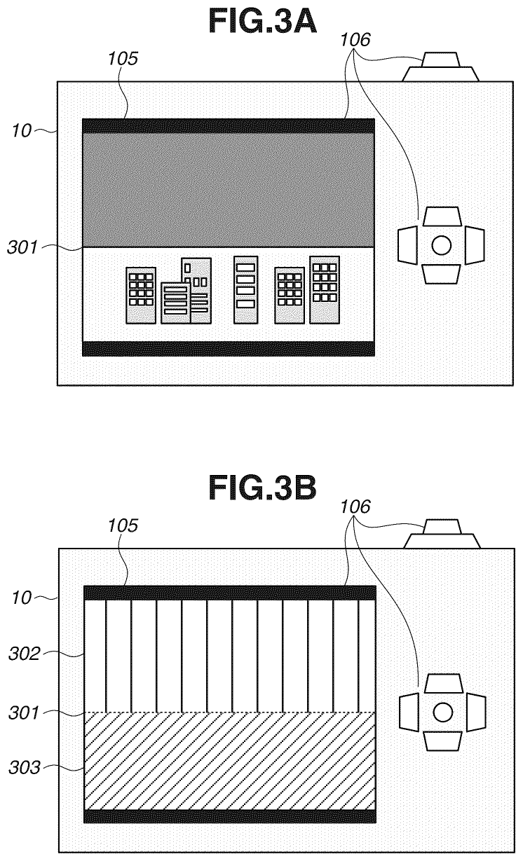

In step S202, the control unit 108 sets divided areas based on an input to the operation unit 106. As illustrated in FIG. 3A, the divided areas are set by a user setting the coordinates of a division line 301 in the area of an image (such as a live view image) displayed on the display unit 105, and dividing the area of the image. The coordinates of the division line 301 are set via a touch panel or a button of the operation unit 106. Referring to FIG. 3B, the area is divided by the division line 301 into a first area 302 and a second area 303. While, in the present exemplary embodiment, the area is divided by a division line, the area may be divided into continuous areas according to the luminance in the image, and each of the continuous areas may be set as a divided area. While, in FIGS. 3A and 3B, the area is divided by the division line 301 alone, the area may be divided by a plurality of division lines.

In step S203, the control unit 108 detects that an imaging instruction has been input from the user via the operation unit 106. The imaging instruction may be input by a full press of the shutter button included in the operation unit 106, for example. Upon detection of the input of the imaging instruction, the control unit 108 executes step S204. In step S204, the control unit 108 executes an imaging processing for one frame. Then, the control unit 108 saves the raw data obtained by the imaging in the memory 109. In imaging of the first frame (the first image after detection of the imaging instruction), the control unit 108 skips the synthesis processing in step S205 and executes step S206. In a case where imaging of the second and subsequent frames is to continue in the flowchart described below, the control unit 108 performs control to execute step S205.

In step S205, the image processing unit 104 generates a new composite image (new composite raw data) by combining the image (raw data) obtained by the most recent imaging with the composite image (composite raw data) of up to the previous frame. The image processing unit 104 executes the synthesis processing according to the selected mode.

In step S206, the control unit 108 displays the composite image generated in step S205 on the display unit 105. In the present exemplary embodiment, since the composite image is raw data, the image processing unit 104 performs the development processing, and the developed composite image is displayed on the display unit 105.

In step S207, the control unit 108 detects whether a synthesis stop instruction for the divided area has been issued, and the processing proceeds to step S208. The synthesis stop instruction is issued by the user selecting an area in which exposure is to be stopped, during a continuous imaging processing, for example. The area is selected by a touch panel (which may be the display unit 105) or a button included in the operation unit 106. For example, in the case of selection via a touch panel, the user touches the divided area of the composite image in which exposure is to be stopped, on the touch panel at the timing when the user wishes to stop exposure while checking the composite image displayed on the display unit 105. In the case of selection by a button, for example, the currently selected divided area is highlighted, whereby the user can check it on the display unit 105, and in a case where the control unit 108 detects the pressing of the button, the synthesis of the area is stopped. The selected area may be changed by pressing a button assigned for area selection, for example.

A case where the control unit 108 detects a synthesis stop instruction in response to a user operation has been described above. The image processing unit 104 may integrate the luminance of the divided area, and in a case where the luminance value reaches or exceeds a predetermined luminance value, the synthesis of the area may be ended. The predetermined luminance value may be a value preset on the camera side, or may be a value that is selected and set by the user via the operation unit 106.

In a case where the control unit 108 determines in step S208 that the synthesis stop instruction has not been issued for all the divided areas (NO in step S208), the control unit 108 executes step S209. In a case where the instruction has been issued for all the divided areas (YES in step S208), the control unit 108 determines that the imaging has ended and executes step S211.

In step S209, the control unit 108 detects whether there is an imaging stop instruction issued by a user operation, and the processing proceeds to step S210. The imaging stop instruction is issued by fully pressing the shutter button included in the operation unit 106, for example. In a case where no imaging stop instruction is detected in step S210 (NO in step S210), the control unit 108 repeatedly executes steps S204 to S208. In this processing, the composite image displayed on the display unit 105 by the control unit 108 in step S206 is the image (raw data) obtained by the most recent imaging (second time point) and a composite image (composite raw data) of up to the previous frame (first time point). That is, the composite image displayed on the display unit 105 by the control unit 108 is updated to the latest composite image.

In a case where the imaging stop instruction has been detected in step S210 (YES in step S210), the control unit 108 determines that imaging has ended, and executes step S211. For example, the control unit 108 controls the imaging apparatus 10 to continuously perform imaging while an imaging instruction is continuously input (while no imaging stop instruction is input).

In step S211, the control unit 108 stops the imaging processing, and the image processing unit 104 develops the composite image that has been processed until that point, and generates an image data file that stores the image data from the developed image data. The generated image data file is sent to the recording unit 107, and the processing proceeds to step S212.

In step S212, the recording unit 107 records the image data file generated in step S211 on a recording medium, such as a memory card. In addition to or instead of the developed image data, the composite raw data may be recorded.

Upon completion of the recording by the recording unit 107, the control unit 108 ends the operations described in FIG. 2 and returns to an imaging standby state, for example. This concludes the description of the flowchart in FIG. 2.

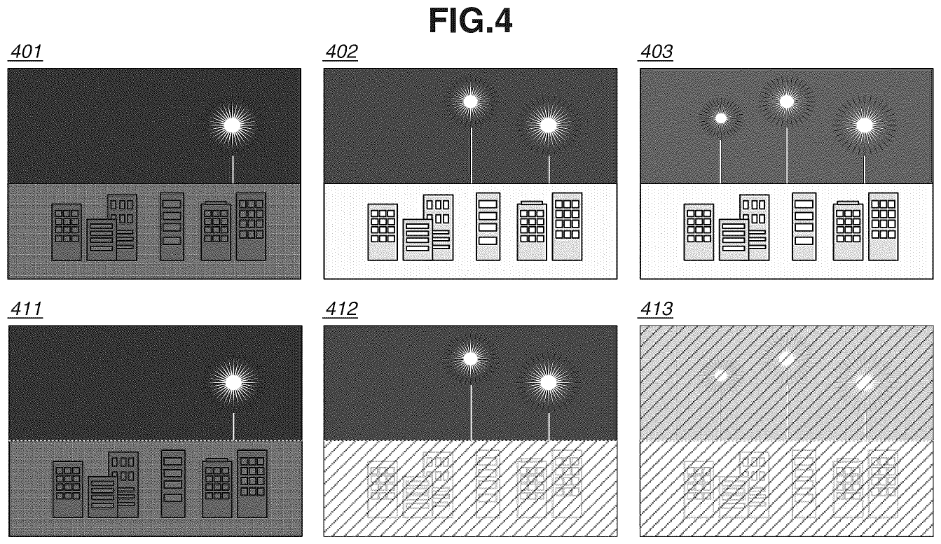

Next, composite images in a series of imaging operations and display of the composite images during imaging will be described with reference to FIG. 4. FIG. 4 illustrates an example of composite images at times t1, t2, and t3 after the start of imaging and a display example of composite images that are displayed on the display unit 105 during imaging. For simplicity, the description will be given based on a case in which the imaging is started and ended in the order of t1, t2, and t3.

A composite image 401 is obtained at the time t1 after the start of imaging, and an image under synthesis 411 is displayed on the display unit 105. The image under synthesis 411 has a white dotted line as a division line, and is divided into two areas. Since no synthesis stop instruction has been issued for any of the areas, the image processing unit 104 performs the synthesis processing on all of the areas.

At the time t2, a composite image 402 is an image obtained when the user issues a synthesis stop instruction of the lower one of the two divided areas, and an image under synthesis 412 is displayed on the display unit 105. The display unit 105 grays out the lower area for which the user has issued the synthesis stop instruction in the image under synthesis 412. For the gray-out display, the image processing unit 104 fills the area for which synthesis has been stopped with a single color in the display image obtained by developing the composite image, and the resultant image is displayed on the display unit 105.

In this processing, the composite image 402 is more lightened in all the areas than the composite image 401. The method of indicating that a synthesis stop instruction has been issued is not limited to this. For example, the user may be notified that synthesis has been ended, with an icon or the like, which indicates the end of synthesis, displayed in a part of the area where synthesis has been stopped. The user may be notified that synthesis has been ended, with a highlight of the outline of the area where synthesis has been stopped.

At the time t3, the user issues a synthesis stop instruction for the upper divided area. A composite image 403 is obtained when synthesis of all the divided areas is stopped, and an image under synthesis 413 is displayed on the display unit 105. Since all the divided areas are selected, the image under synthesis 411 is grayed out, and imaging is ended. At this time, since synthesis has been stopped for the lower divided area, only the upper area of the composite image 403 is more lightened than the composite image 402, whereby the exposure time and brightness are changeable for each of the divided areas.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-040477, which was filed on Mar. 14, 2024 and which is hereby incorporated by reference herein in its entirety.

What is claimed is:

1. An image processing apparatus, comprising:
at least one memory storing instructions; and
at least one processor in communication with the at least one memory and configured to execute the instructions, wherein execution of the instructions causes the at least one memory and the at least one processor to:
divide each of a plurality of images captured continuously over time into similar areas;
generate a composite image from the plurality of images by synthesis processing; and
control a display device to display the composite image,
wherein the synthesis processing for each of the areas divided by the dividing is ended based on an end instruction.

2. The image processing apparatus according to claim 1, wherein the dividing divides each of the plurality of images into two or more areas.

3. The image processing apparatus according to claim 1, further comprising:
an instruction member configured to provide instructions,
wherein the instruction member is capable of selecting at least one of the divided areas.

4. The image processing apparatus according to claim 1, wherein, as the composite image, a first composite image is generated from a plurality of images captured until a first time point, and a second composite image is newly generated using images captured after the first time point.

5. The image processing apparatus according to claim 1, wherein execution of the instructions causes the at least one memory and the at least one processor to:
perform control to change the display on the display device every time a new composite image is generated.

6. The image processing apparatus according to claim 5, wherein execution of the instructions causes the at least one memory and the at least one processor to change a display form of an area of the composite image in which synthesis processing has ended, on the display device.

7. The image processing apparatus according to claim 6, wherein execution of the instructions causes the at least one memory and the at least one processor to highlight the area of the composite image in which the synthesis processing has ended.

8. The image processing apparatus according to claim 1, wherein the composite image is an image to which an effect of longer exposure than the plurality of images, which has been captured over time and used to create the composite image, is applied.

9. The image processing apparatus according to claim 1, wherein the composite image is created by any one of addition synthesis, addition averaging, and comparative brightening.

10. An imaging apparatus comprising:
an image sensor;
at least one memory storing instructions; and
at least one processor in communication with the at least one memory and configured to execute the instructions, wherein execution of the instructions causes the at least one memory and the at least one processor to:
divide each of a plurality of images captured continuously over time into similar areas;
generate a composite image from the plurality of images by synthesis processing; and
control a display device to display the composite image,
wherein the synthesis processing for each of the areas divided by the dividing is ended based on an end instruction.

11. An image processing method executed by an image processing apparatus, comprising:
dividing each of a plurality of images captured continuously over time into similar areas;
generating a composite image by combining the plurality of images by synthesis processing;
displaying the composite image,
wherein the synthesis processing is ended for each of the divided areas based on an end instruction.

12. A non-transitory computer-readable storage medium which stores a program for causing a computer to execute an image processing method comprising:
dividing each of a plurality of images captured continuously over time into similar areas;
generating a composite image by combining the plurality of images by synthesis processing;
displaying the composite image,
wherein the synthesis processing is ended for each of the divided areas based on an end instruction.
